(19) United States
(12) Patent Application Publication
(10) Pub. No.: US 2016/0045391 A1
(43) Pub. Date: Feb. 18, 2016

(54) Exercise Aid

(71) Applicant: David Strassburg, Northampton, MA (US)

(72) Inventor: David Strassburg, Northampton, MA (US)

(21) Appl. No.: 14/748,156

(22) Filed: Jun. 23, 2015

Related U.S. Application Data
(60) Provisional application No. 62/015,934, filed on Jun. 23, 2014.

(51) Int. Cl. A61H 15/00

(52) U.S. Cl. CPC A61H 15/00

(57) ABSTRACT

The present disclosure provides a roller that can be used to facilitate all of the equipment that a runner needs, and especially on race day. The roller has a cylindrical body with a first end cap and a second end cap at opposing ends. The first end cap and/or the second end cap is removable such that objects can be placed within the roller and contained therein. Each end cap has an orifice through which a strap is disposed. In this way, the strap can be used to sling the roller over the shoulder for easy portability.

### CROSS-REFERENCE TO RELATED APPLICATIONS

This application claims priority to U.S. Provisional Application No. 62/015,934, filed on Jun. 23, 2014, now pending, the disclosure of which is incorporated herein by reference.

### FIELD OF THE DISCLOSURE

The present disclosure relates to therapeutic aid for exercising, and in particular to foam rollers for exercising.

### BACKGROUND OF THE DISCLOSURE

Runners and other athletes can have a variety of items needed for an activity. For example, a runner may have a wallet, keys, snack bars, drink(s), therapeutic devices, etc. At the same time, it is not convenient or beneficial to run while carrying such items. One therapeutic device that has become popular with athletes is the foam roller. Such rollers can be used for stretching or massage muscles before or after athletic activities. Athletes have struggled with conveniently carrying their needed items to and from events.

### BRIEF SUMMARY OF THE DISCLOSURE

The present disclosure provides a roller that can be used to facilitate all of the equipment that a runner needs, and especially on race day. The present roller can be a foam roller and includes end caps, at least one of which is removable. In this way, a runner can use the roller to contain items. For example, a runner can place keys, snack bars, drinks, wallet, etc. within the roller. The roller further includes a strap through the interior of the roller which may be used as a sling to carry the roller over a shoulder. The strap is removable from the roller and configured to be used around the torso of a runner to secure a runner's bib. As such, the strap includes tabs for securing the bib.

### DESCRIPTION OF THE DRAWINGS

For a fuller understanding of the nature and objects of the disclosure, reference should be made to the following detailed description taken in conjunction with the accompanying drawings, in which:

FIG. 1 is a perspective view of a roller according to the present disclosure;

FIG. 2 is a front view of the roller of FIG. 1;

FIG. 3 is a right-side view of the roller of FIGS. 1-2;

FIG. 4 is a back view of the roller of FIGS. 1-3;

FIG. 5 is a left-side view of the roller of FIGS. 1-4;

FIG. 6 is a top view of the roller of FIGS. 1-5;

FIG. 7 is a bottom view of the roller of FIGS. 1-6;

FIG. 8 is a perspective view of two rollers (without straps) of the present disclosure affixed to one another; and

FIG. 9 is a perspective view of a cylindrical body of a roller with an end cap removed to show the interior of the cylindrical body.

### DETAILED DESCRIPTION OF THE DISCLOSURE

While the present disclosure will be described and referenced with respect to runners, it should be recognized that the disclosed device may be useful for any athlete or other individual who benefits from the use of a roller. Therefore, the present disclosure should not be limited to runners.

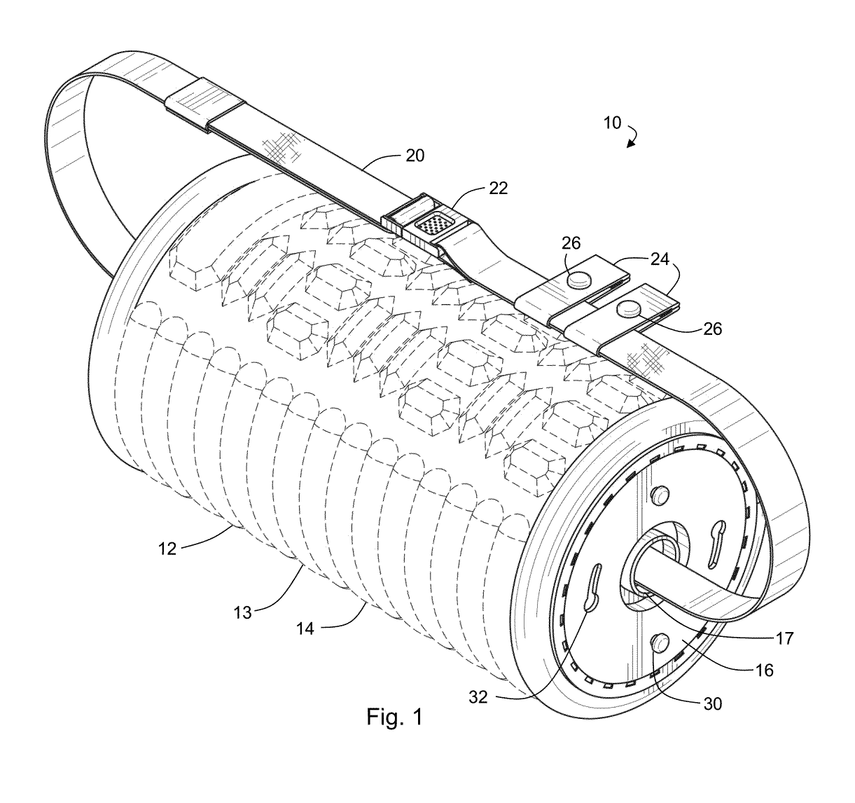

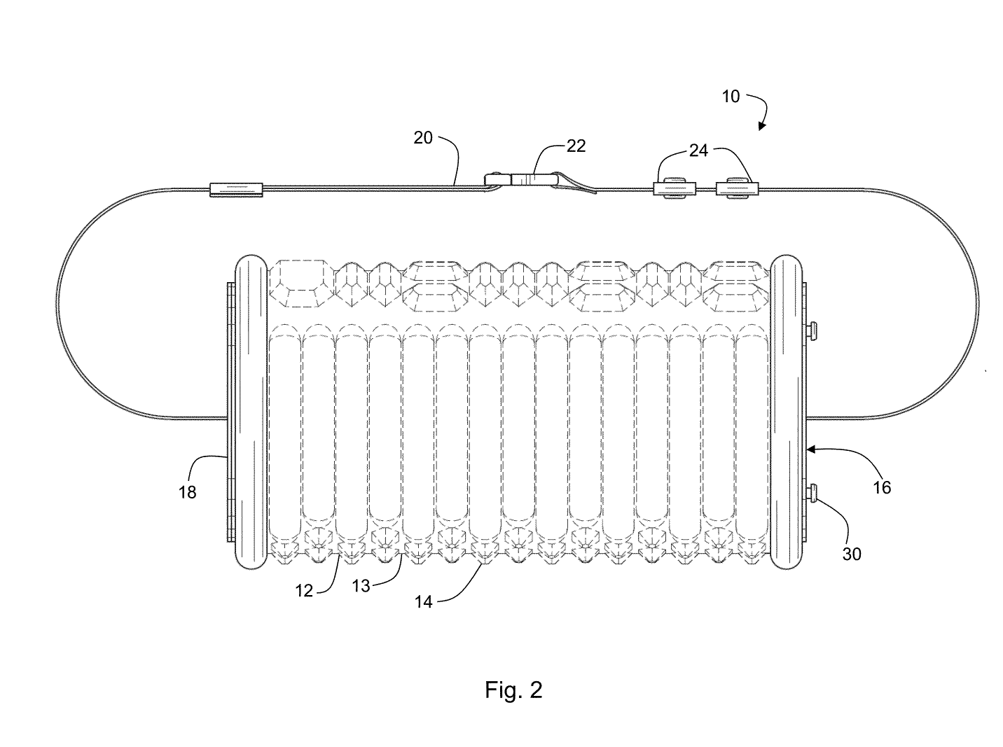

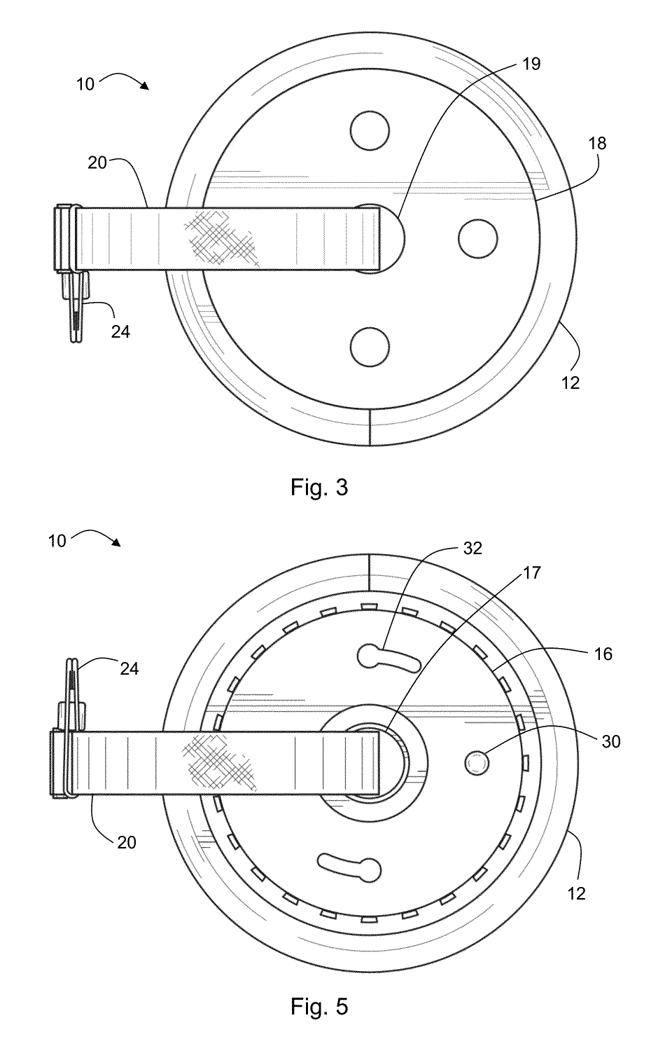

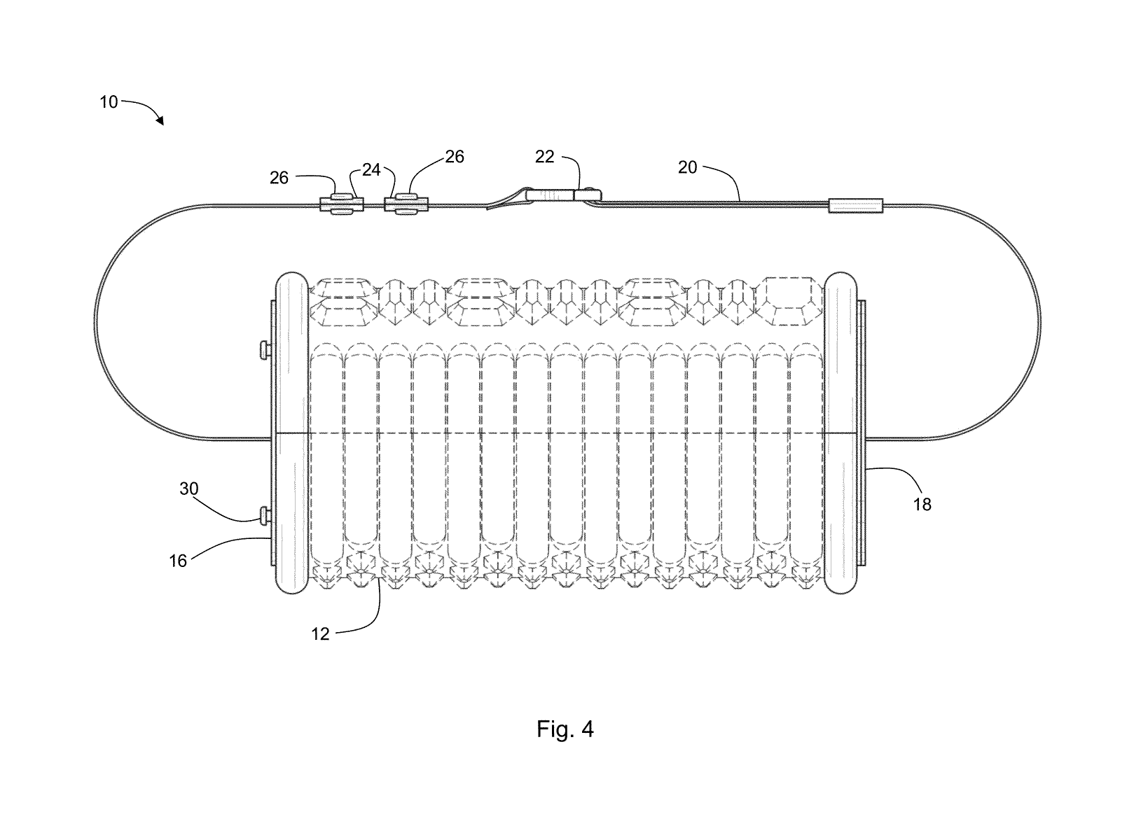

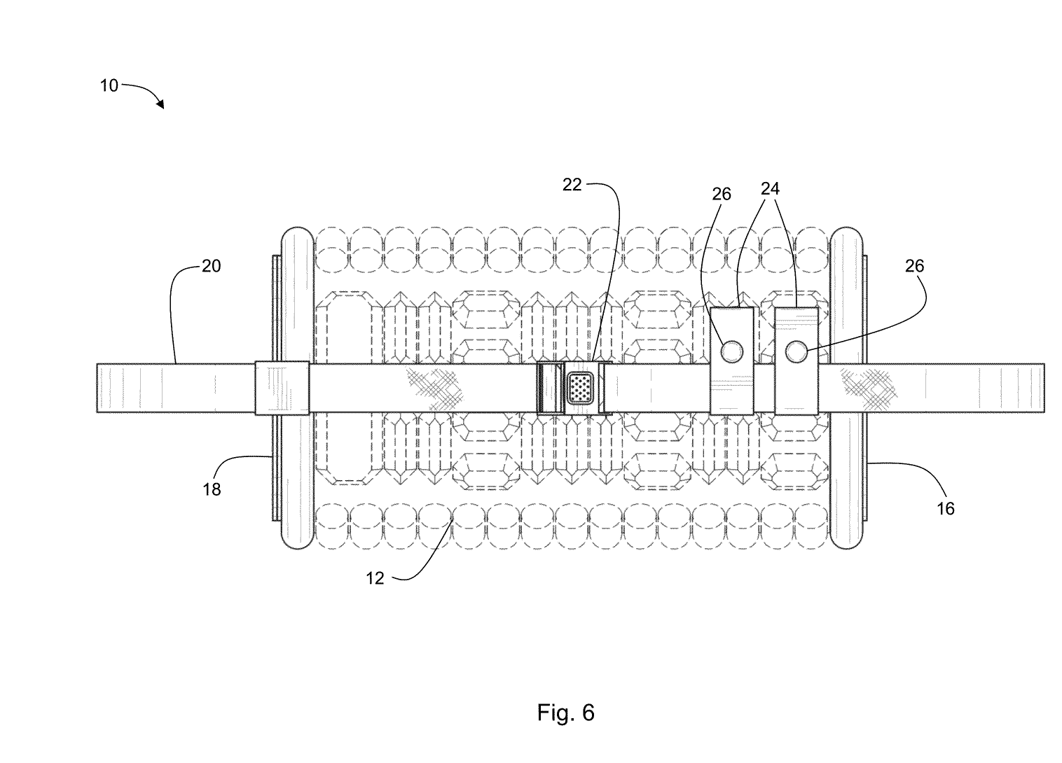

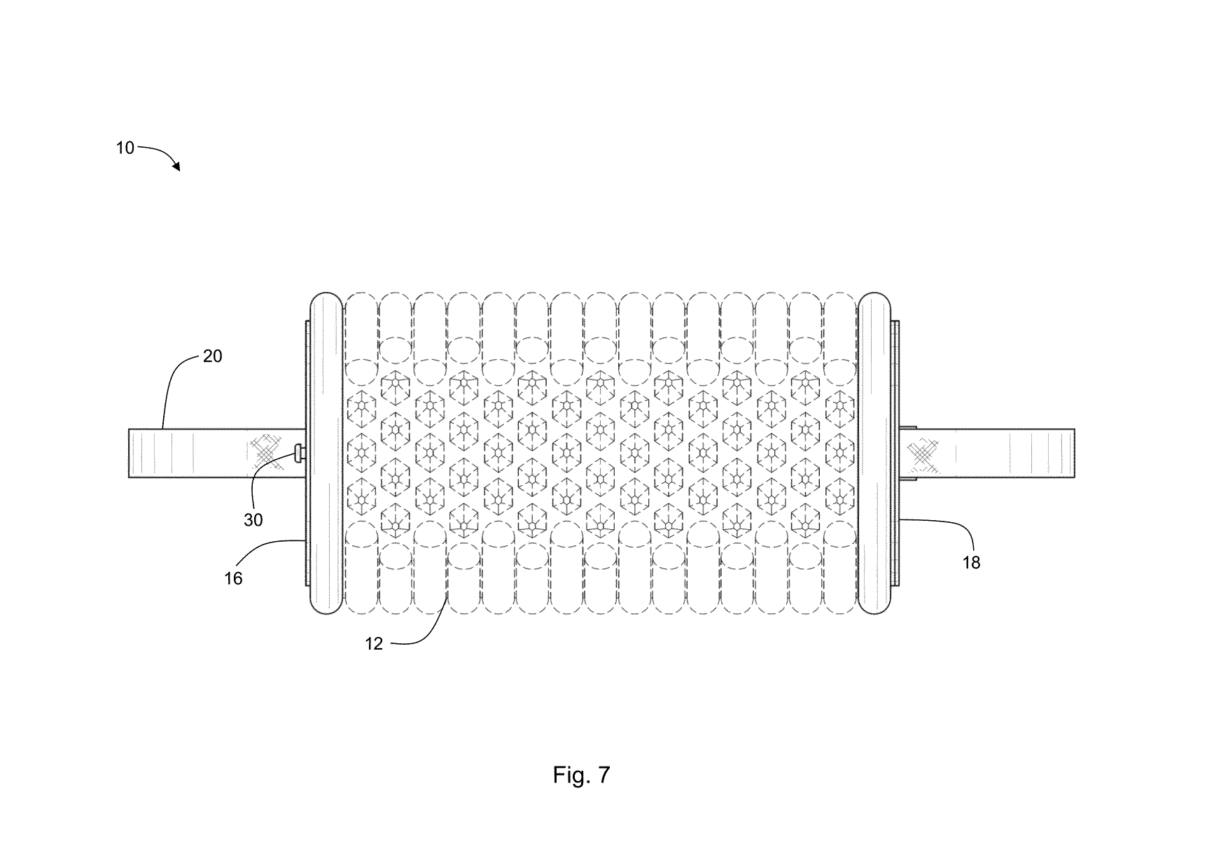

With reference to FIGS. 1-8, the present disclosure may be embodied as a roller 10 having a cylindrical body 12. The cylindrical body 12 may be made of foam or any other material suitable for such a device, and combinations of such materials. The cylindrical body 12 has a wall 13 with an outer surface 14. The cylindrical body 12 may be hollow. The outer surface 14 may be textured for enhanced performance, such as, for example, better massage characteristics.

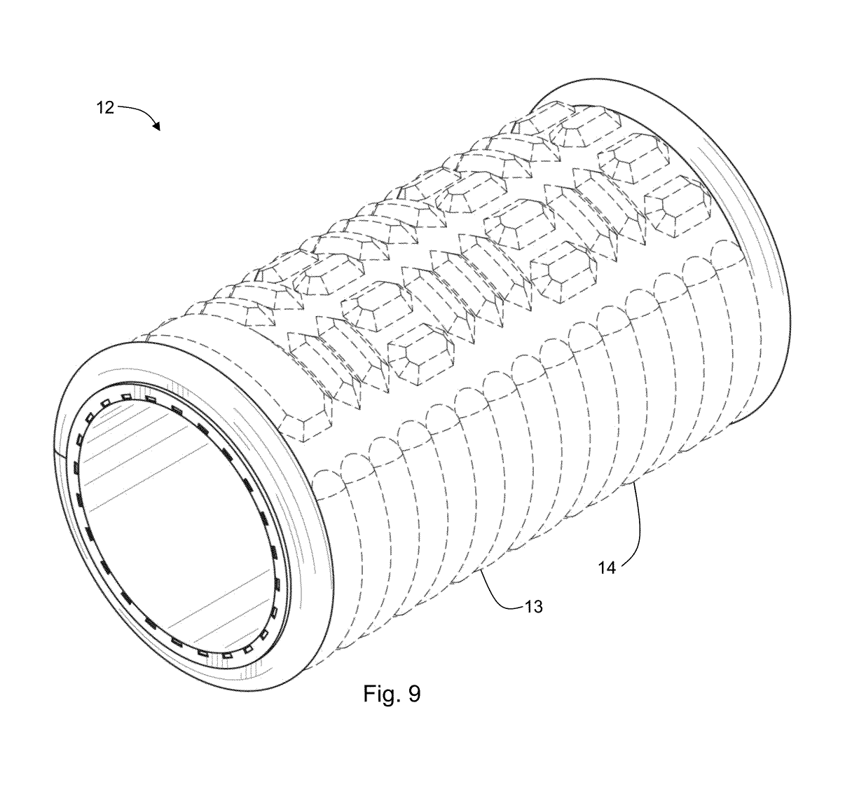

The roller 10 comprises a first end cap 16 and a second end cap 18 at respective ends of the cylindrical body 12. At least one of the first and/or second end caps 16, 18 are removable from the cylindrical body 12 (see FIG. 9). For example, the first end cap 16 may be configured for threaded engagement with the cylindrical body 12. Other configurations will be known in light of the present disclosure, such as, for example, friction fit, quarter-turn, etc. The first end cap 16 has an orifice 17 and the second end cap 18 has an orifice 19.

The roller 10 further comprises a strap 20 disposed through the orifices 17, 19 and around a wall 13 of the cylindrical body 12. The strap 20 includes a closure 22 such that the strap 20 is removable. The closure may be a snap, buckle, or other closures known in the art. The strap 20 has a length that may be adjustable such that the strap 20 may be formed into a closed loop having an adjustable size. In this way, the strap 20 may be considered a sling 20 such that the roller 10 may be carried over a shoulder by way of the sling 20.

When removed from the roller 10, the strap 20 may be arranged around the torso of a runner The strap 20 comprises two tabs 24 configured to attach to a runner's bib. In this way, the runner may use the strap 20 of the roller 10 to secure a bib during an event. At least one of the tabs 24 may be at a fixed location along the length of the strap 20 such that the bib does not migrate during the run. At least one of the tabs 24 may be free to move along the length of the strap 20 so that various bib sizes and configurations may be accommodated. Each tab 24 may include a securement 26 for attaching the bib. For example, each tab 24 may have a snap, a clip, or any other form of securement 26 appropriate in light of the present disclosure.

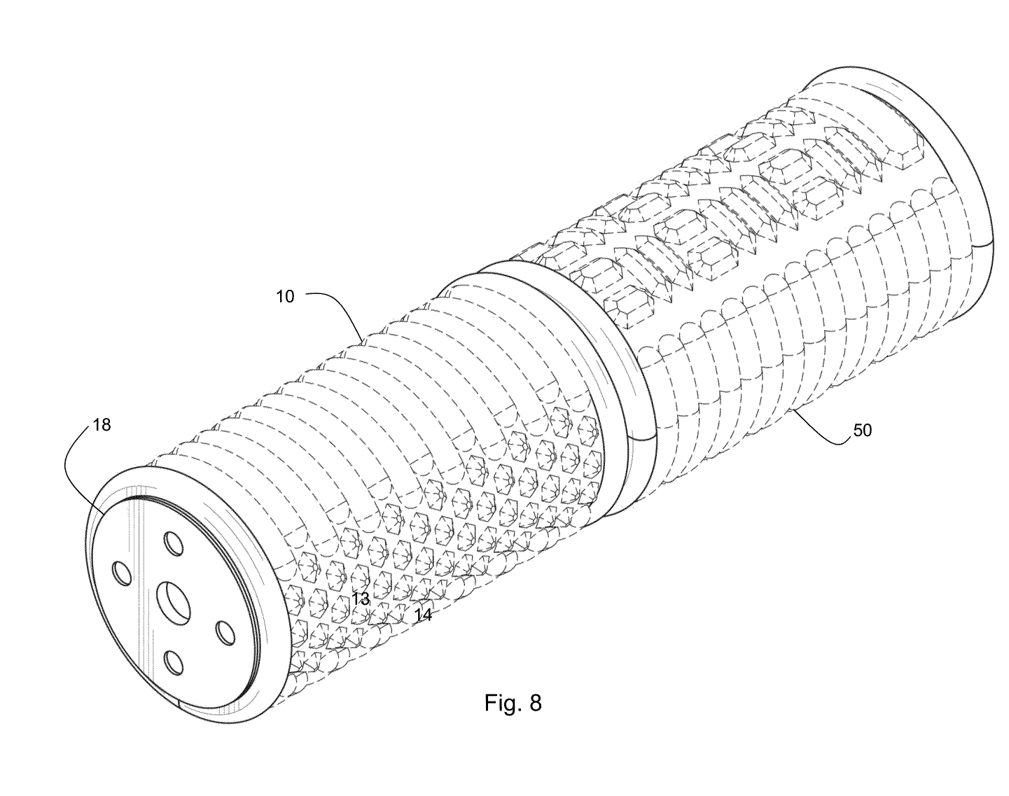

In some embodiments, the first and second end caps 16, 18 of a roller 10 are configured to cooperate with the end caps of a second roller 50 (see FIG. 8). For example, the first end cap 16 may be have studs 30 and the second end cap 18 may have keyhole slots 32 configured to engage with the studs 30 of a first end cap. In this way, rollers 10, 50 may be adjoined to one another to form a longer device. Such a longer device may be useful where the rollers 10, 50 are used on a larger area of the body—e.g., the back. Other suitable cooperating structures will be apparent for connecting rollers in light of the present disclosure. In other embodiments, one or both of the end caps 16, 18 may be configured to connect with either the first or second end cap of a second roller. For example, FIG. 1 shows wherein the first end cap 16 includes both studs 30 and keyhole slots 32 such that the first end cap 16 may be attached to a similarly configure end cap of a second roller.

Although the present disclosure has been described with respect to one or more particular embodiments, it will be understood that other embodiments of the present disclosure may be made without departing from the spirit and scope of the present disclosure. Hence, the present disclosure is deemed limited only by the appended claims and the reasonable interpretation thereof.

What is claimed is:

1. A roller for runners, comprising:
a cylindrical body having a first end cap and a second end cap, each of the first end cap and second end cap having an orifice, at least one of the first end and/or the second end being removable; and
a removable strap disposed through the orifices of the first and second end caps, the removable strap further comprising at least two tabs configured to attach to a runner's bib.

2. The roller of claim 1, wherein the first end cap and second end cap are configured such that the first end cap can be attached to the second end cap of a second roller to adjoin two rollers.

3. The roller of claim 1, wherein the removable strap is adjustable in length.

4. The roller of claim 1, wherein the cylindrical body comprises a foam outer surface.

5. The roller of claim 4, wherein the foam outer surface of the foam roller has a surface with a texture.

6. The roller of claim 1, wherein the first end cap and/or the second end cap is removably attached to the cylindrical body by way of threaded engagement.

7. The roller of claim 1, wherein the tabs of the removable strap have snaps for attaching a runner's bib.

8. The roller of claim 1, wherein the cylindrical body is hollow.
